(19) United States
(12) Patent Application Publication
(10) Pub. No.: US 2024/0004364 A1
(43) Pub. Date: Jan. 4, 2024

(54) DISPLAY APPARATUS AND DISPLAY METHOD

(71) Applicant: SEIKO EPSON CORPORATION, Tokyo (JP)

(72) Inventors: Junichi TAKIGAWA, MATSUMOTO-SHI (JP); Masaki MOTOYOSHI, AZUMINO-SHI (JP); Shota HIRAMATSU, SHIOJIRI-SHI (JP)

(21) Appl. No.: 18/215,187

(22) Filed: Jun. 28, 2023

(30) Foreign Application Priority Data
Jun. 30, 2022 (JP) 2022-106660

(51) Int. Cl. G05B 19/4069; G05B 19/402

(52) U.S. Cl. CPC G05B 19/4069; G05B 19/402; G05B 2219/40264; G05B 2219/37252; G05B 2219/31466

(57) ABSTRACT

A display apparatus includes an acquisition unit acquiring a basic motion program, a life calculation unit calculating a first life of a robot arm when a motion is performed based on the basic motion program acquired by the acquisition unit, a creation unit creating a corrected motion program for setting a life of the robot arm to be a second life longer than the first life using the same configuration of the robot arm and work start position and work end position of a control point as those of the basic motion program and changing a position of a proximal end of the robot arm, and a display unit displaying a position of the proximal end of the robot arm in the corrected motion program.

The present application is based on, and claims priority from JP Application Serial Number 2022-106660, filed Jun. 30, 2022, the disclosure of which is hereby incorporated by reference herein in its entirety.

### BACKGROUND

### 1. Technical Field

The present disclosure relates to a display apparatus and a display method.

### 2. Related Art

Recently, in factories, due to rises in labor costs and shortages of human resources, work of manufacturing, processing, assembly, etc. has been performed using robots having robot arms and work that had been manually performed has been acceleratingly automated.

When speed conditions of the robot arms or the like are not properly set in work motions for the robots, lives of the respective components forming the robot arms may be shorter and cycle times of work may be longer than those in proper settings.

For example, JP-A-2013-144349 discloses a robot reducer life estimation simulation apparatus that predicts a life of a reducer provided inside of a robot arm. In the robot reducer life estimation simulation apparatus, the life of the reducer is estimated by estimation of a rotation speed of the reducer and a load on the reducer based on an input motion program.

However, in the robot reducer life estimation simulation apparatus disclosed in JP-A-2013-144349, motion conditions for the robot to move in order to improve the life of the reducer are unknown.

### SUMMARY

A display apparatus according to an application example of the present disclosure includes an acquisition unit acquiring a basic motion program containing information on a configuration of a robot arm, a work start position and a work end position of a control point set for the robot arm, a position of a proximal end of the robot arm, an attitude of the robot arm in a motion path from the work start position to the work end position, and a speed of the robot arm in the motion path, a life calculation unit calculating a first life of the robot arm when a motion is performed based on the basic motion program acquired by the acquisition unit, a creation unit creating a corrected motion program for setting a life of the robot arm to be a second life longer than the first life using the same configuration of the robot arm and work start position and work end position of the control point as those of the basic motion program and changing the position of the proximal end of the robot arm, and a display unit displaying a position of the proximal end of the robot arm in the corrected motion program.

A display method according to an application example of the present disclosure includes an acquisition step of acquiring a basic motion program containing information on a configuration of a robot arm, a work start position and a work end position of a control point set for the robot arm, a position of a proximal end of the robot arm, an attitude of the robot arm in a motion path from the work start position to the work end position, and a speed of the robot arm in the motion path, a life calculation step of calculating a first life of the robot arm when a motion is performed based on the basic motion program acquired at the acquisition step, a creation step of creating a corrected motion program for setting a life of the robot arm to be a second life longer than the first life using the same configuration of the robot arm and work start position and work end position of the control point as those of the basic motion program and changing the position of the proximal end of the robot arm, and a display step of displaying a position of the proximal end of the robot arm in the corrected motion program.

### BRIEF DESCRIPTION OF THE DRAWINGS

FIG. 1 shows an overall configuration of a robot system including a first embodiment of a display apparatus executing a display method of the present disclosure.

FIG. 2 is a block diagram of the robot system shown in FIG. 1.

FIG. 3 is a block diagram of the display apparatus shown in FIG. 1.

FIG. 4 shows a process of setting candidate areas where a robot arm is placed by the display apparatus shown in FIG. 1.

FIG. 5 shows the process of setting the candidate areas where the robot arm is placed by the display apparatus shown in FIG. 1.

FIG. 6 shows an example of an input screen displayed by the display apparatus shown in FIG. 2.

FIG. 7 shows an example of the display screen displayed by the display apparatus shown in FIG. 2.

FIG. 8 is a flowchart for explanation of an example of the display method of the present disclosure.

### DESCRIPTION OF EXEMPLARY EMBODIMENTS

As below, a display apparatus and a display method of the present disclosure will be explained in detail based on preferred embodiments shown in the accompanying drawings.

### First Embodiment

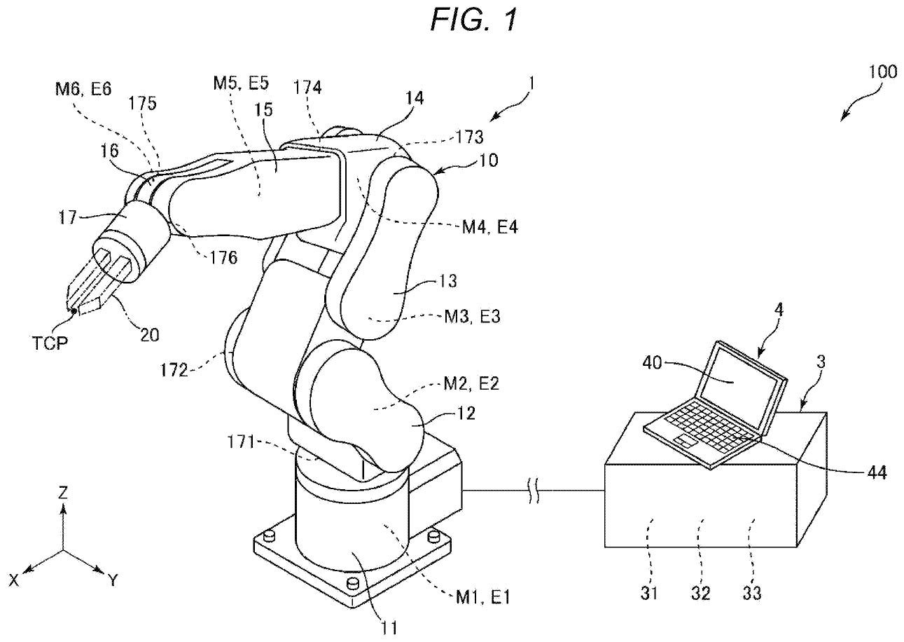

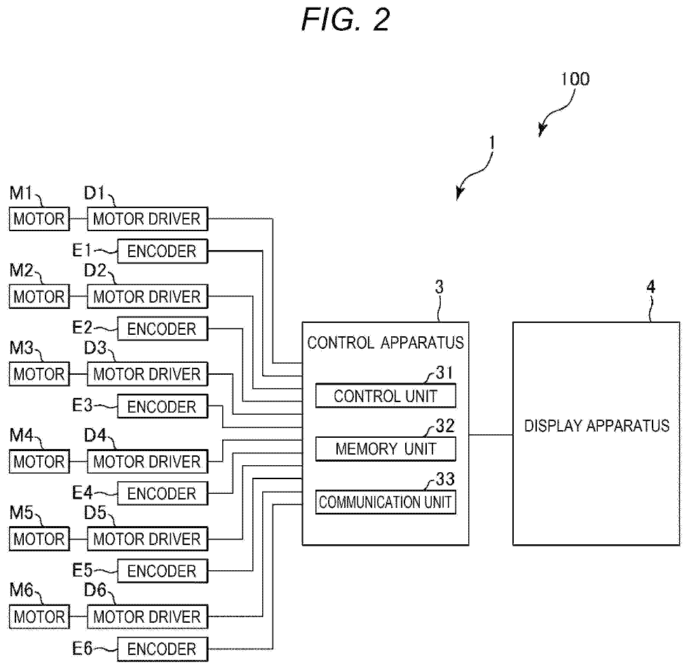

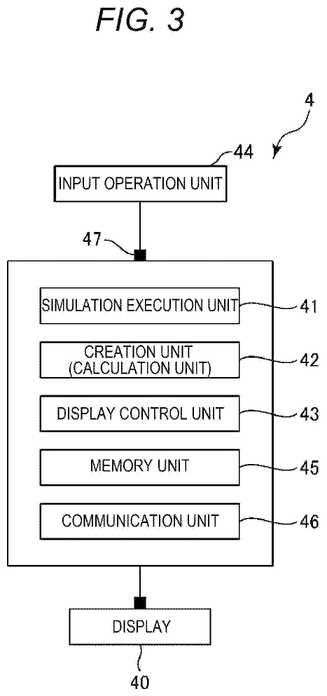

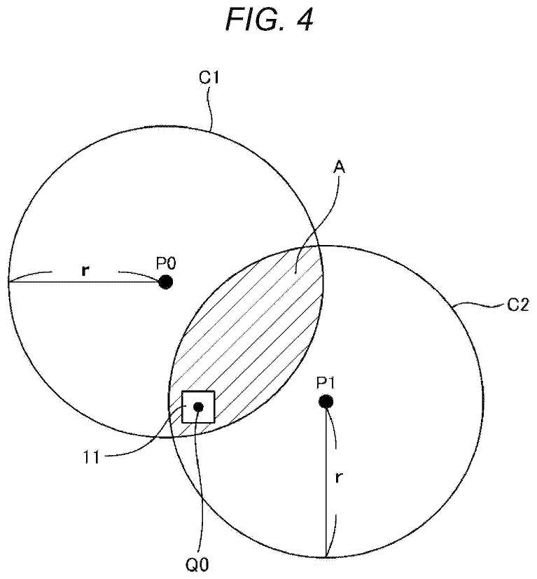

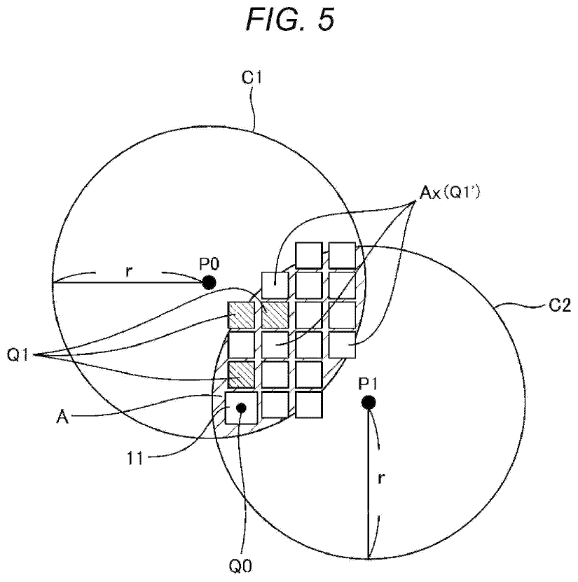

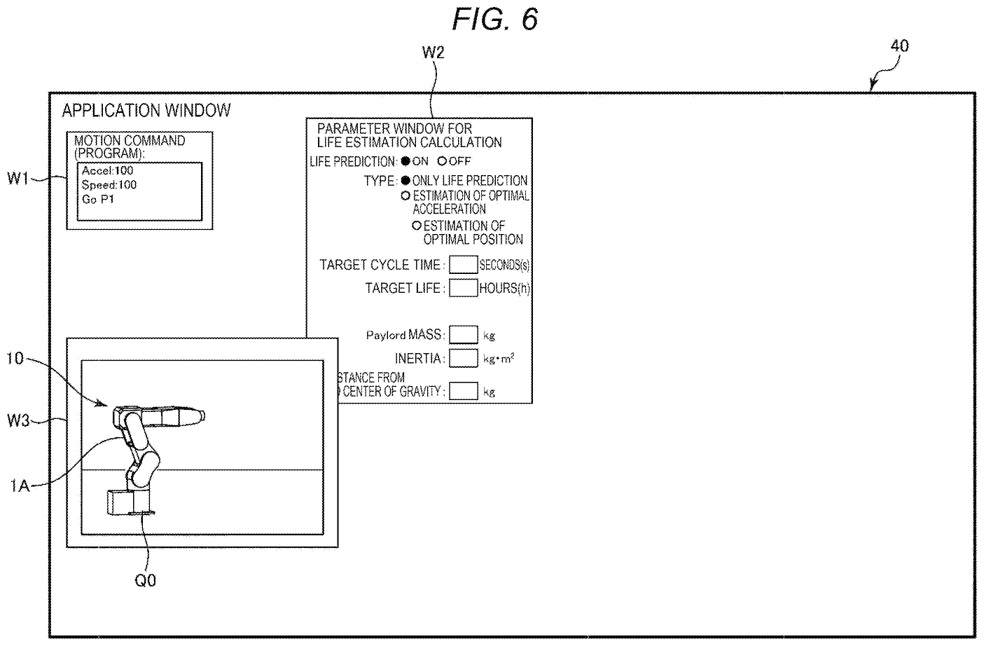

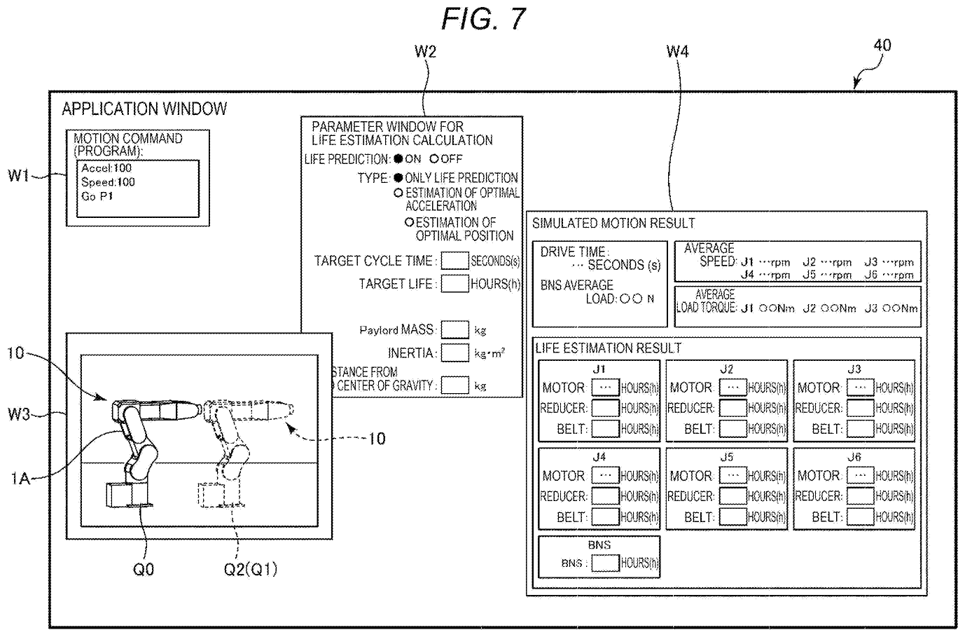

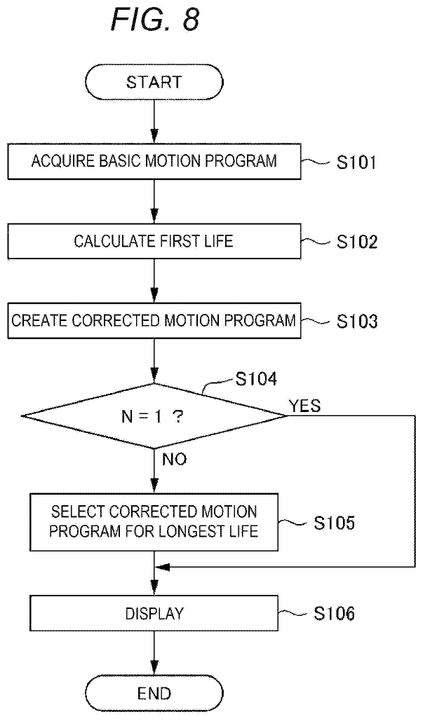

FIG. 1 shows an overall configuration of a robot system including a first embodiment of a display apparatus executing a display method of the present disclosure. FIG. 2 is a block diagram of the robot system shown in FIG. 1. FIG. 3 is a block diagram of the display apparatus shown in FIG. 1. FIG. 4 shows a process of setting candidate areas where a robot arm is placed by the display apparatus shown in FIG. 1. FIG. 5 shows the process of setting the candidate areas where the robot arm is placed by the display apparatus shown in FIG. 1. FIG. 6 shows an example of an input screen displayed by the display apparatus shown in FIG. 2. FIG. 7 shows an example of the display screen displayed by the display apparatus shown in FIG. 2. FIG. 8 is a flowchart for explanation of an example of the display method of the present disclosure.

Hereinafter, for convenience of explanation, an X-axis, a Y-axis, and a Z-axis in FIG. 1 are axes orthogonal to one another, Z-axis directions in FIG. 1 are referred to as “vertical directions”, any directions on an XY-plane containing the X-axis and the Y-axis are referred to as “horizontal directions”, and the XY-plane is referred to as “horizontal plane”. Further, with respect to a robot arm, a base 11 in FIG. 1 is also referred to as “proximal end” and the opposite side thereto, i.e., an end effector 20 is also referred to as “distal end”.

As shown in FIG. 1, a robot system 100 includes a robot 1, a control apparatus 3 controlling actuation of the respective units of the robot 1, and a teaching apparatus 4 of the present disclosure.

First, the robot 1 is explained.

The robot 1 shown in FIG. 1 is a single-arm six-axis vertical articulated robot in the embodiment and has the base 11 and a robot arm 10. The end effector 20 may be attached to the distal end portion of the robot arm 10. Note that the end effector 20 may be a component element of the robot 1, or a separate member from the robot 1, that is, not a component element of the robot 1.

The robot 1 is not limited to the illustrated configuration, but may be e.g., a dual-arm articulated robot. Or, the robot 1 may be a horizontal articulated robot.

The base 11 is a supporter drivably supporting the proximal end of the robot arm 10 and fixed to e.g., a floor within a factory. The base 11 of the robot 1 is electrically coupled to the control apparatus 3 via a relay cable. Note that the coupling between the robot 1 and the control apparatus 3 is not limited to the wired coupling like the configuration shown in FIG. 1, but may be e.g., wireless coupling. Or, the robot and the control apparatus may be coupled via a network such as the Internet.

In the embodiment, the robot arm 10 has a first arm 12, a second arm 13, a third arm 14, a fourth arm 15, a fifth arm 16, and a sixth arm 17 and these arms are sequentially coupled from the base 11 side. Note that the number of arms of the robot arm 10 is not limited to six, but may be one, two, three, four, five, seven, or more. The sizes including the entire lengths of the respective arms are respectively not particularly limited, but can be appropriately set.

The base 11 and the first arm 12 are coupled via a joint 171. Further, the first arm 12 is pivotable around a first pivot axis extending in vertical directions as a pivot center relative to the base 11. The first pivot axis is aligned with the normal of the floor surface of the floor to which the base 11 is fixed, and the whole robot arm 10 may rotate in both a forward direction and a backward direction around the first pivot axis.

The first arm 12 and the second arm 13 are coupled via a joint 172. Further, the second arm 13 is pivotable around a second pivot axis extending in the horizontal directions as a pivot center relative to the first arm 12.

The second arm 13 and the third arm 14 are coupled via a joint 173. Further, the third arm 14 is pivotable around a third pivot axis extending in the horizontal directions as a pivot center relative to the second arm 13. The third pivot axis is parallel to the second pivot axis.

The third arm 14 and the fourth arm 15 are coupled via a joint 174. Further, the fourth arm 15 is pivotable around a fourth pivot axis parallel to the center axis directions of the third arm 14 as a pivot center relative to the third arm 14. The fourth pivot axis is orthogonal to the third pivot axis.

The fourth arm 15 and the fifth arm 16 are coupled via a joint 175. Further, the fifth arm 16 is pivotable around a fifth pivot axis as a pivot center relative to the fourth arm 15. The fifth pivot axis is orthogonal to the fourth pivot axis.

The fifth arm 16 and the sixth arm 17 are coupled via a joint 176. Further, the sixth arm 17 is pivotable around a sixth pivot axis as a pivot center relative to the fifth arm 16. The sixth pivot axis is orthogonal to the fifth pivot axis.

The sixth arm 17 is a robot distal end portion located at the most distal end side of the robot arm 10. The sixth arm 17 may be displaced together with the end effector 20 by driving of the robot arm 10.

The end effector 20 shown in FIG. 1 has a gripping portion that may grip a workpiece or a tool. In a state in which the end effector 20 is attached to the sixth arm 17, the distal end portion of the end effector 20 is a control point TCP.

The robot 1 includes a motor M1, a motor M2, a motor M3, a motor M4, a motor M5, and a motor M6 as drive units and an encoder E1, an encoder E2, an encoder E3, an encoder E4, an encoder E5, and an encoder E6. The motor M1 is provided inside the joint 171 and rotates the first arm 12 around the first pivot axis relative to the base 11. The motor M2 is provided inside the joint 172 and relatively rotates the first arm 12 and the second arm 13 around the second pivot axis. The motor M3 is provided inside the joint 173 and relatively rotates the second arm 13 and the third arm 14 around the third pivot axis. The motor M4 is provided inside the joint 174 and relatively rotates the third arm 14 and the fourth arm 15 around the fourth pivot axis. The motor M5 is provided inside the joint 175 and relatively rotates the fourth arm 15 and the fifth arm 16 around the fifth pivot axis. The motor M6 is provided inside the joint 176 and relatively rotates the fifth arm 16 and the sixth arm 17 around the sixth pivot axis.

Further, the encoder E1 is provided inside the joint 171 and detects the position of the motor M1. The encoder E2 is provided inside the joint 172 and detects the position of the motor M2. The encoder E3 is provided inside the joint 173 and detects the position of the motor M3. The encoder E4 is provided inside the joint 174 and detects the position of the motor M4. The encoder E5 is provided inside the fifth arm 16 and detects the position of the motor M5. The encoder E6 is provided inside the sixth arm 17 and detects the position of the motor M6. Note that “detect the position” here is to detect the rotation angle of the motor, i.e., an amount of forward or backward rotation and an angular speed, and the detected information is referred to as “position information”.

As shown in FIG. 2, motor driver D1 to motor driver D6 are coupled to the corresponding motor M1 to motor M6, respectively, and control driving of the motors. The motor driver D1 to motor driver D6 are provided inside the joint 171, the joint 172, the joint 173, the joint 174, the fifth arm 16, and the sixth arm 17, respectively.

The encoder E1 to encoder E6, the motor M1 to motor M6, and the motor driver D1 to motor driver D6 are respectively electrically coupled to the control apparatus 3. The position information of the motor M1 to motor M6 detected by the encoder E1 to encoder E6, i.e., the amounts of rotation are transmitted as electrical signals to the control apparatus 3. The control apparatus 3 outputs control signals to the motor driver D1 to motor driver D6 shown in FIG. 2 to drive the motor M1 to motor M6 based on the position information. That is, to control the robot arm 10 is to control driving of the motor M1 to motor M6 to control actuation of the first arm 12 to sixth arm 17 of the robot arm 10.

The end effector 20 may be detachably attached to the distal end portion of the robot arm 10. In the embodiment, the end effector 20 includes a hand having a pair of claw portions movable close to or apart from each other and gripping and releasing the workpiece or a tool by the respective claw portions. A force detector attached to the end effector 20 may detect magnitude and direction of a reaction force of a gripping force when the claw portions grip the workpiece.

Note that the end effector 20 is not limited to the illustrated configuration, but may have e.g., a suction portion and grip the workpiece or a tool by suction using the suction portion. Or, the end effector 20 may be a tool e.g., a polisher, a grinder, a cutter, a spray gun, a laser beam irradiator, a driver, a wrench, or the like.

Next, the control apparatus 3 and the display apparatus 4 will be explained.

As shown in FIG. 1, the control apparatus 3 is placed in a position apart from the robot 1 in the embodiment. The control apparatus 3 is not limited to the configuration, but may be provided inside the base 11. Further, the control apparatus 3 has a function of controlling driving of the robot 1 and is electrically coupled to the above described respective units of the robot 1. The control apparatus 3 has the control unit 31, a memory unit 32, and the communication unit 33. These respective units are coupled to mutually communicate via e.g., a bus.

The control unit 31 includes e.g., a CPU (Central Processing Unit) and reads out and executes various programs such as a motion program stored in the memory unit 32. The signals generated by the control unit 31 are transmitted to the respective units of the robot 1 via the communication unit 33 and the signals from the respective units of the robot 1 are received by the control unit 31 via the communication unit 33. Thereby, the robot arm 10 may execute predetermined work in predetermined conditions.

The memory unit 32 stores the various programs etc. to be executed by the control unit 31. The memory unit 32 includes e.g., a volatile memory such as a RAM (Random Access Memory), a nonvolatile memory such as a ROM (Read Only Memory), and a detachable external memory device.

The communication unit 33 transmits and receives signals between the control apparatus 3 and itself using an external interface, e.g., a wired LAN (Local Area Network), a wireless LAN, or the like. In this case, the communication may be made via a server (not shown) or via a network such as the Internet.

As shown in FIGS. 1, 2, and 3, the display apparatus 4 is an apparatus predicting the life of the robot arm 10 before the start of work (work motion) and displaying a proper installation position (hereinafter, referred to as “position Q1 of the proximal end of the robot arm 10”, “position Q1 of the base 11”, or “position Q1”) according to the prediction result. Specifically, the display apparatus 4 calculates a first life of the robot arm 10 based on a basic motion program input by the user, calculates a corrected motion program for setting a second life longer than the first life, and displays a proper set position of the robot 1, i.e., the position Q1 contained in the corrected motion program.

Further, “proper placement position of the robot arm 10” as below refers to the position Q1 in which, when the robot arm 10 repeatedly performs a motion following the same motion path, the load on the respective units of the robot arm 10 is reduced and the life becomes longer.

In addition, the display apparatus 4 also serves as a teaching apparatus teaching the robot 1. Note that the teaching function may not be provided in the display apparatus 4, but the teaching apparatus may be formed as another device than the display apparatus 4.

The basic motion program refers to a program prepared for the robot 1 to perform intended predetermined work by the user. The basic motion program contains information on a configuration of the robot arm 10, a work start position P0 and a work end position P1 of the control point TCP set for the distal end portion of the robot arm 10, a position Q0 of the proximal end of the robot arm 10, an attitude of the robot arm 10 in a motion path from the work start position P0 to the work end position P1, and a speed of the robot arm 10 in the motion path, and temporal changes of the position and the attitude of the robot arm 10 are determined based on the information.

As below, as an example, a work motion to grip a mounted workpiece in the work start position P0, move the gripped workpiece to the work end position P1, and release the gripping is taken as shown in FIG. 4. The motion performed once is referred to as “one cycle” and a time taken for one cycle is referred to as “cycle time”.

The information of “configuration of the robot arm 10” contained in the basic motion program is information unique to the type of the robot arm 10 and specifying a model number, a manufacturing date, components forming the robot arm 10, etc. The information of the components forming the robot arm is information of the types of the encoder E1 to encoder E6, the types of the motor M1 to motor M6, etc.

The information of “position of the proximal end of the robot arm 10” contained in the basic motion program is information on the position of the base 11 during the work motion and specifying three-dimensional position and direction in a predetermined coordinate system.

The information of “motion path” contained in the basic motion program is temporal position information of the control point TCP. In the embodiment, as shown in FIG. 4, the path from the work start position P0 as a start point to the work end position P1 as an end point is “motion path”. The work start position P0 is e.g., a position where a workpiece mounted on a workbench or the like is gripped. The work end position P1 is e.g., a position where the movement of the gripped workpiece is completed and the gripping of the workpiece is released.

The information of “attitude of the robot arm 10 in the motion path” contained in the basic motion program is information of the temporal attitude of the robot arm 10 during the work motion and the angles of the respective joints 171 to 176.

The information of “speed of the robot arm 10” contained in the basic motion program is temporal information of rotation speeds of the respective joints 171 to 176 and accelerations of the respective joints 171 to 176.

The display apparatus 4 has a display 40 as a display unit and an input operation unit 44 and includes a notebook personal computer in the embodiment.

Note that the display apparatus 4 may also serve as a teaching apparatus teaching a work motion program to the robot arm 10.

The input operation unit 44 includes a keyboard and a mouse (not shown) and the user appropriately operates these to perform input operation of various kinds of information including the basic motion program. The display 40 includes e.g., liquid crystal, organic EL, or the like and may display various display screens such as an input screen DI and a display screen DO, which will be described later, in colors or black and white. Note that the display apparatus 4 is not limited to the notebook personal computer, but may be a desktop personal computer or a tablet terminal. A terminal taking in the information input by the input operation unit 44 forms an acquisition unit 47. The information acquired by the acquisition unit 47 includes the basic motion program for execution of the work motion and information input for estimation of the life. As described above, the acquisition unit 47 may also be a basic motion program acquisition unit.

The display apparatus 4 has a simulation execution unit 41, a creation unit 42, a display control unit 43, a memory unit 45, and a communication unit 46.

The memory unit 45 includes e.g., a volatile memory such as a RAM (Random Access Memory), a nonvolatile memory such as a ROM (Read Only Memory), and a detachable external memory device. Further, in the memory unit 45, information acquired by the acquisition unit 47, particularly, the basic motion program, a corrected motion program created by the creation unit 42, etc. are stored.

The communication unit 46 transmits and receives signals between the control apparatus 3 and itself using an external interface, e.g., a wired LAN (Local Area Network), a wireless LAN, or the like. In this case, the communication may be made via a server (not shown) or via a network such as the Internet. The communication unit 46 transmits information on the motion program stored in the memory unit 45 etc. to the control apparatus 3. Further, the communication unit 46 may receive the information stored in the memory unit 32 and store the information in the memory unit 45.

The simulation execution unit 41 includes at least one processor such as a CPU or a GPU and functions as a life calculation unit calculating the life of the robot arm 10. The life of the robot arm 10 refers to lives of the respective components forming the robot arm 10 and, one life as a shortest life, i.e., one life having a shortest period to a failure may be regarded as the life of the robot arm 10. Of the respective components forming the robot arm 10, the main components include power sources or power transmission system components e.g., the motor M1 to motor M6, reducers placed in those motors, various ball screw splines, various belts, etc. These have shorter lives of the respective components forming the robot arm 10 and are typical examples of components as indices for determining the life of the robot arm 10. Note that the components as indices for determining the life of the robot arm 10 may include other components than those of the power sources or power transmission system components.

The method of determining the life of the robot arm 10 is not limited to that described above.

The simulation execution unit 41 performs a simulation using a life estimation simulation model by driving of the robot arm 10 stored in the memory unit 45 and calculates the life of the robot arm 10. The simulation execution unit 41 performs the simulation using the life estimation simulation model, and thereby, information on the life of the robot arm 10 when the robot arm is moved in a predetermined motion condition may be acquired. That is, the simulation execution unit 41 acquires information on the life of the robot arm 10 when the robot arm is moved by the basic motion program (hereinafter, also referred to as “first life”).

The information input to the life estimation simulation model includes information input by the user from the input screen DI such as various kinds of information contained in the above described basic motion program, a target cycle time, a mass of a workpiece, inertia, and a distance from a rotation axis to the center of gravity. The information may be input by the user from the input screen DI displayed on the display 40.

As above, the simulation execution unit 41 is described as an example of the life calculation unit, however, not limited to that in the present disclosure. The life calculation unit may be a unit obtaining the life of the robot arm 10 with reference to a multidimensional table showing relationships between the above described input values and output values or obtaining the life using various numerical expressions.

The creation unit 42 includes at least one processor such as a CPU or a GPU and reads out and executes a program stored in the memory unit 45. That is, at least one corrected motion program for setting the life of the robot arm 10 to be the second life longer than the first life is created using the same configuration of the robot arm 10 and work start position P0 and work end position P1 of the control point TCP of the robot arm 10 as those of the basic motion program and appropriately changing the position Q0 of the proximal end of the robot arm 10. In other words, in the basic motion program, with the other elements than the position Q0 of the proximal end of the robot arm 10 unchanged, a more proper position of the proximal end of the robot arm 10, i.e., at least one position Q1 where the life becomes longer is obtained.

The method of obtaining the position Q1 of the proximal end of the robot arm 10 by the creation unit 42 is as follows.

First, as shown in FIG. 4, as seen from the vertical direction, a circle C1 having a radius r around the work start position P0 is set and a circle C2 having a radius r around the work end position P1 is set. The circle C1 is an area where the control point TCP may move on the assumption that the base 11 is placed in the work start position P0. The circle C2 is an area where the control point TCP may move on the assumption that the base 11 is placed in the work end position P1.

Here, the radius r may be changed according to the heights of the work start position P0 and the work end position P1.

Then, an area A in which the circle C1 and the circle C2 overlap is extracted and a plurality of candidate areas Ax as candidates for the area where the base 11 is placed are set in the area A. The candidate area Ax has the same shape as the shape of the base 11 as seen from the vertical direction, i.e., a rectangular shape. The center position of the candidate area Ax is set as the position Q1 of the base 11. In the illustrated configuration, the candidate areas Ax are set in the entire of the area A so that the adjacent candidate areas Ax may not overlap.

Note that the candidate areas Ax may be set so that at least part of the candidate areas Ax may overlap, not limited to the above described configuration.

Then, the creation unit 42 creates the corrected motion program by placing the base 11 in each candidate area of all set candidate areas Ax and using substantially the same configuration of the robot arm 10, work start position P0 and work end position P1 of the control point TCP, and cycle time. The respective corrected motion programs corresponding to the respective candidate areas Ax are different in position Q1 of the base 11, and thus, different in position and attitude of the robot arm 10 during the motion.

Then, the simulation execution unit 41 executes simulations using the respective corrected motion programs and calculates lives respectively corresponding thereto. Of the respective calculated lives, the lives longer than the first life are the second lives. In positions Q1′ corresponding to the respective candidate areas Ax, some lives are the second lives longer than the first life and the others are not, and the positions of the second lives are set as the positions Q1. In FIG. 5, there are the three positions Q1 shown by hatching.

The display apparatus 4 has a selection section (not shown), when the creation unit 42 creates a plurality of corrected motion programs, that is, when there are a plurality of second lives, selecting one corrected motion program. In the embodiment, the selection section is placed in the creation unit 42. Note that the selection section may be placed or formed in another part than the creation unit 42 of the display apparatus.

For example, the selection section selects one corrected motion program from the plurality of corrected motion programs using the following selection methods (1) to (3). The position of the proximal end of the robot arm 10, i.e., the position of the base 11 in the corrected motion program selected by the selection section is set as a position Q2.

(1) The corrected motion program for setting the longest life is selected. That is, the life of the robot arm 10 is calculated with respect to each of the plurality of corrected motion programs, the corrected motion program for setting the longest life of the robot arm 10 is selected from the programs and specified.

Thereby, the longest life of the robot arm 10 may be set. Therefore, more proper work may be performed over a longer period.

(2) The corrected motion program for setting the position Q1 of the proximal end of the robot arm 10 to be closest to the position Q0 of the proximal end of the robot arm 10 in the basic motion program is selected and specified.

Thereby, the movement distance of the robot arm 10, i.e., the distance between the positions Q0 and Q1 may be set to be as short as possible and work may be started quickly and easily.

(3) When simulations are performed on the respective corrected motion programs sequentially one by one, the corrected motion program for first calculating the second life is selected and specified.

Thereby, the number of simulations may be reduced and the time taken for the selection may be reduced. Therefore, work may be started quickly.

In the embodiment, the selection section selects the corrected motion program using the selection method (1). That is, of the information on the plurality of positions Q1, information on the position Q2 of the proximal end of the robot arm 10 in the corrected motion program selected by the selection section is specified and the information on the position Q2 is displayed on the display 40.

The display control unit 43 has a function of controlling actuation of the display 40. The display control unit 43 includes at least one processor such as a CPU or a GPU and reads out and executes a program stored in the memory unit 45. Thereby, display information displayed on the display 40 may be designated. The display information includes the input screen DI shown in FIG. 6 and the display screen DO shown in FIG. 7.

On the input screen D1, a motion command window W1, a parameter window W2, and a simulated image window W3 are displayed.

In the motion command window W1, characters “Accel: 100”, characters “Speed: 100”, and characters “Go P1” are displayed. “Accel: 100” shows that the acceleration when the control point TCP moves is set to MAX in the acquired basic motion program. “Speed: 100” shows that the speed of the control point TCP is set to MAX in the acquired basic motion program. “Go P1” shows that the final target position is the work end position P1 in the acquired basic motion program. These characters are changed according to the contents of the basic motion program.

In the parameter window W2, select portions for ON/OFF of a life prediction mode and input portions for a target cycle time, the mass of the workpiece, the inertia, and the distance from the rotation axis to the center of gravity are displayed.

The life calculation may be performed additionally with these elements. Particularly, the mass of the workpiece has a larger direct influence on the life. The life is calculated additionally with the mass of the workpiece, and thereby, a more accurate life may be calculated.

In the simulated image window W3, an image of a virtual robot 1A corresponding to the robot 1 is displayed. The type of the displayed image of the virtual robot 1A includes one or both of a still image and a moving image.

A shape, a configuration, a motion, etc. of the robot arm 10 in the virtual robot 1A displayed in the simulated image window W3 correspond to a shape, a configuration, a motion, etc. of the robot arm 10 in the real robot 1. Positions Q0, Q1, and Q2 of the virtual robot 1A displayed in the simulated image window W3 correspond to positions Q0, Q1, Q2 of the real robot 1.

On the display screen DO, a simulated motion result window W4 is displayed in addition to the above described motion command window W1, parameter window W2, and simulated image window W3.

In the simulated image window W3 on the display screen DO, together with the robot arm 10 and the position Q0 thereof in the basic motion program, the robot arm 10 and the position Q1 thereof in the corrected motion program, i.e., the robot arm 10 and the position Q1 thereof for a longer life are displayed in different display patterns.

Particularly, when there are a plurality of positions Q1, the robot arm 10 and the position Q2 thereof in the corrected motion program selected by the selection section are displayed with the robot arm 10 and the position Q0 thereof in the basic motion program.

In the illustrated configuration, as the different display patterns, the robot arm 10 in the position in the basic motion program is displayed by solid lines and the robot arm 10 in the position for the longer life is displayed by broken lines.

Another example of the different display patterns includes e.g., differences in gray level or color and one lighting and the other blinking with respect to all or part of the robot arm 10, however, not limited to those.

Note that, when the creation unit 42 does not create a plurality of corrected motion programs, but creates one corrected motion program, selection by the selection section is not performed and the robot arm 10 and the position Q1 thereof in the one corrected motion program are displayed. The same applies to a case where the display apparatus 4 does not have the selection section.

The user may view the above described display screen DO and move the robot arm 10 of the real robot 1 to a proper position Q2 (Q1). After the robot arm 10 is moved, a work motion is performed using the corrected motion program corresponding to the proper position Q2 (Q1), and thereby, compared to a case where the work motion is performed using the basic motion program in a position Q0 before the movement, the load on the respective components of the robot arm 10 tends to be lighter and the life of the robot arm 10 may be longer.

As described above, the display apparatus 4 includes the acquisition unit 47 acquiring the basic motion program containing the information on the configuration of the robot arm 10, the work start position P0 and the work end position P1 of the control point set for the robot arm 10, the position Q0 of the proximal end of the robot arm 10, the attitude of the robot arm in the motion path from the work start position P0 to the work end position P1, and the speed of the robot arm 10 in the motion path, the simulation execution unit 41 as the life calculation unit calculating the first life of the robot arm 10 when the motion is performed based on the basic motion program acquired by the acquisition unit 47, the creation unit 42 creating the corrected motion program for setting the life of the robot arm 10 to be the second life longer than the first life using the same configuration of the robot arm, work start position P0 of the control point TCP of the robot arm 10, and work end position P1 of the control point TCP of the robot arm 10 as those of the basic motion program and changing the position Q0 of the proximal end of the robot arm 10, and the display 40 as the display unit displaying the position Q1 of the proximal end of the robot arm 10 in the corrected motion program. Thereby, the user may easily and quickly perceive the position to place the proximal end of the robot arm 10 for the longer life of the robot 1.

Further, when creating the plurality of corrected motion programs, the creation unit 42 selects the corrected motion program for setting the longest life of the programs, and the display 40 as the display unit displays the position Q2 of the proximal end of the robot arm 10 in the selected corrected motion program. Thereby, the load on the respective units of the robot arm 10 when the robot arm 10 performs the work motion may be further reduced and the life of the robot arm 10 may be further extended.

The display 40 as the display unit displays the position Q2 of the proximal end of the robot arm 10 in the selected corrected motion program as the simulated image of the robot arm 10. Thereby, the user may visually perceive the position Q2 of the proximal end of the robot arm 10 easily and accurately.

Further, the display 40 as the display unit displays the position Q0 of the proximal end of the robot arm 10 in the basic motion program with the simulated image of the robot arm 10. Thereby, the relative position relationship between the position Q2 of the proximal end of the robot arm 10 in the selected corrected motion program and the position Q0 of the proximal end of the robot arm 10 in the basic motion program may be easily and quickly perceived. Therefore, the user may move the robot arm 10 to the position Q2 before work more accurately and quickly.

Furthermore, the display 40 as the display unit displays the position Q0 of the proximal end of the robot arm 10 in the basic motion program and the position Q2 of the proximal end of the robot arm 10 in the selected corrected motion program in the different display patterns. Thereby, the user may distinguish and clearly recognize the position Q2 of the proximal end of the robot arm 10 in the corrected motion program and the position Q0 of the proximal end of the robot arm 10 in the basic motion program.

Next, the example of the display method executed by the display apparatus of the present disclosure will be explained using the flowchart shown in FIG. 8.

First, at step S101, the basic motion program is acquired. That is, the acquisition unit 47 acquires the basic motion program input by the user operating the input screen DI. This step S101 is an acquisition step of acquiring the basic motion program.

Then, at step S102, the first life is calculated. That is, the simulation execution unit 41 performs the simulation using the life estimation simulation model, and thereby, acquires the first life of the robot arm 10 when the robot arm is moved in the predetermined motion condition. This step S102 is a life calculation step of calculating the first life.

Then, at step S103, the corrected motion program is created. That is, the creation unit 42 obtains the proper position of the position Q0 of the proximal end of the robot arm 10, i.e., the position Q1 for the longer life with the other elements than the position Q0 of the proximal end of the robot arm 10 unchanged. The obtainment method is described as above. This step S103 is a creation step of creating the corrected motion program. One or some corrected motion program may be created.

Then, at step S104, whether a number N (N is a natural number) of the created corrected motion programs is one is determined. That is, whether the number N of the obtained positions Q1 is one is determined. When N=1, the processing goes to step S106 and, when N 2, the processing goes to step S105.

At step S105, the corrected motion program for setting the longest life is selected from the plurality of created corrected motion programs, the position of the proximal end of the robot arm 10 in the selected corrected motion program is set as the position Q2, and the processing goes to step S106.

Then, at step S106, the created corrected motion program is displayed. Specifically, when the number of the created corrected motion programs is one, the position Q1 of the proximal end of the robot arm 10 in the corrected motion program is displayed and, when the number of the created corrected motion programs is two or more, the position Q2 of the proximal end of the robot arm 10 in the corrected motion program selected from the programs is displayed.

The display control unit 43 controls actuation of the display 40 to display the position Q1 or Q2 of the proximal end of the robot arm 10 in the corrected motion program with the position Q0, i.e., the display screen DO.

As described above, the display method of the present disclosure includes the acquisition step of acquiring the basic motion program containing the information on the configuration of the robot arm 10, the work start position P0 and the work end position P1 of the control point TCP set for the robot arm 10, the position Q0 of the proximal end of the robot arm 10, the attitude of the robot arm 10 in the motion path from the work start position P0 to the work end position P1, and the speed of the robot arm 10 in the motion path, the life calculation step of calculating the first life of the robot arm 10 when the motion is performed based on the basic motion program acquired at the acquisition step, the creation step of creating at least one corrected motion program for setting the life of the robot arm 10 to be the second life longer than the first life using the same configuration of the robot arm, work start position P0 of the control point TCP of the robot arm 10, and work end position P1 of the control point TCP of the robot arm 10 as those of the basic motion program and changing the position Q0 of the proximal end of the robot arm 10, and the display step of displaying the position Q1 of the proximal end of the robot arm 10 in the corrected motion program. Thereby, the user may easily and quickly perceive the position to place the proximal end of the robot arm 10 for the longer life.

As above, the display apparatus and the display method of the present disclosure are explained based on the illustrated embodiments, however, the present disclosure is not limited to those. Any step may be added to the display method. The respective units of the display apparatus may be replaced by any structures that may exert the same functions. Further, any structure may be added thereto.

What is claimed is:

1. A display apparatus comprising:
an acquisition unit acquiring a basic motion program containing information on a configuration of a robot arm, a work start position and a work end position of a control point set for the robot arm, a position of a proximal end of the robot arm, an attitude of the robot arm in a motion path from the work start position to the work end position, and a speed of the robot arm in the motion path;
a life calculation unit calculating a first life of the robot arm when a motion is performed based on the basic motion program acquired by the acquisition unit;
a creation unit creating a corrected motion program for setting a life of the robot arm to be a second life longer than the first life using the same configuration of the robot arm and work start position and work end position of the control point as those of the basic motion program and changing the position of the proximal end of the robot arm; and
a display unit displaying a position of the proximal end of the robot arm in the corrected motion program.

2. The display apparatus according to claim 1, wherein
when creating a plurality of corrected motion programs, the creation unit selects the corrected motion program for setting the longest life of the programs, and
the display unit displays a position of the proximal end of the robot arm in the selected corrected motion program.

3. The display apparatus according to claim 2, wherein
the display unit displays the position of the proximal end of the robot arm in the selected corrected motion program as a simulated image of the robot arm.

4. The display apparatus according to claim 3, wherein
the display unit displays the position of the proximal end of the robot arm in the basic motion program with the simulated image of the robot arm.

5. The display apparatus according to claim 4, wherein
the display unit displays the position of the proximal end of the robot arm in the basic motion program and the position of the proximal end of the robot arm in the selected corrected motion program in different display patterns.

6. A display method comprising:
an acquisition step of acquiring a basic motion program containing information on a configuration of a robot arm, a work start position and a work end position of a control point set for the robot arm, a position of a proximal end of the robot arm, an attitude of the robot arm in a motion path from the work start position to the work end position, and a speed of the robot arm in the motion path;
a life calculation step of calculating a first life of the robot arm when a motion is performed based on the basic motion program acquired at the acquisition step;
a creation step of creating a corrected motion program for setting a life of the robot arm to be a second life longer than the first life using the same configuration of the robot arm and work start position and work end position of the control point as those of the basic motion program and changing the position of the proximal end of the robot arm; and
a display step of displaying a position of the proximal end of the robot arm in the corrected motion program.
